(19) United States
(12) Patent Application Publication
(10) Pub. No.: US 2015/0084928 A1
(43) Pub. Date: Mar. 26, 2015

(54) TOUCH-ENABLED FIELD SEQUENTIAL COLOR DISPLAY USING IN-CELL LIGHT SENSORS

(71) Applicant: QUALCOMM Incorporated, San Diego, CA (US)

(72) Inventors: John Michael Wyrwas, Berkeley, CA (US); Paul Eric Jacobs, La Jolla, CA (US); Evgeni Petrovich Gousev, Saratoga, CA (US); Russell Wayne Gruhlke, Milpitas, CA (US); Chung-Po Huang, San Jose, CA (US); Hae-Jong Seo, San Jose, CA (US); Xiquan Cui, San Jose, CA (US); Jacek Maitan, Mountain View, CA (US)

(21) Appl. No.: 14/034,376

(22) Filed: Sep. 23, 2013

(51) Int. Cl. G06F 3/042

(52) U.S. Cl. CPC G06F 3/0421
USPC 345/175

(57) ABSTRACT

This disclosure provides systems, methods and apparatus for touch and gesture recognition, using a field sequential color display. The display includes a processor, a lighting system, and an arrangement for spatial light modulation that includes an array of light modulators. Each light modulator is switchable between an open position that permits transmittance of light from the lighting system through a respective aperture and a shut position that blocks light transmission through the respective aperture. The processor switches the light modulators in accordance with a first modulation scheme to render an image and in accordance with a second modulation scheme to selectively pass object illuminating light through at least one of the respective apertures. A light sensor receives light resulting from interaction of the object illuminating with an object and outputs a signal to the processor. The processor recognizes, from the output of the light sensor, a characteristic of the object.

### TECHNICAL FIELD

This disclosure relates to techniques for touch and gesture recognition, and, more specifically, to a field sequential color (FSC) display that provides a user input/output interface, controlled responsively to a user's touch and/or gesture.

### DESCRIPTION OF THE RELATED TECHNOLOGY

Electronic devices such as smart phones, tablets, laptops, personal computers, and the like increasingly feature a touchscreen user interface. The power, cost and durability requirements typical of handheld devices are not well-achieved by known techniques. For example, projected capacitance touch (PCT), presently the most commonly used technology for handheld devices, generally employs transparent layers of indium tin oxide (ITO) or other transparent conductor materials stacked together above the display. This reduces the clarity of the display, adds significant cost, and additional controller electronics are needed to read out the finger locations. In addition, there can be cross talk and noise between the display electronics and the touch electronics, reducing the performance of both.

A multi-touch-technology wherein a planar light guide with a light turning arrangement is disposed substantially between a display backlight system and a front surface is one solution to add touch functionality to a field sequential color (FSC). However, this solution may require adding an additional light-guide layer, which may increase cost and thickness.

Thus, improved techniques for providing a touch screen interface are desirable.

### SUMMARY

The systems, methods and devices of the disclosure each have several innovative aspects, no single one of which is solely responsible for the desirable attributes disclosed herein.

One innovative aspect of the subject matter described in this disclosure includes a field sequential color (FSC) display, having a display front surface including a viewing area, the FSC display including a transparent substrate, a display lighting system, at least one light sensor, and a plurality of light modulators for spatial light modulation. Each light modulator includes a shutter assembly configured as a micro electromechanical (MEM) device disposed proximate to a rear surface of the transparent substrate. Each light modulator is configured to be switched between an open position that permits transmittance of light from the display lighting system through a respective aperture to the front surface and a shut position that blocks light transmission through the respective aperture. The transparent substrate is disposed substantially parallel to the front surface and between the display backlight system and the front surface. The transparent substrate is configured to pass light emitted by the display lighting system toward the display front surface and to receive light reflected through the display front surface from an object. The light sensor is disposed within the viewing area and proximate to the rear surface of the transparent substrate.

In some implementations, the display lighting system may include at least one infrared (IR) light emitter, configured to emit IR light into an optical cavity, the optical cavity including a light turning arrangement for redirecting the emitted IR light through the transparent substrate and the display front surface. The light sensor may include an IR light sensor. The transparent substrate may be configured to pass the emitted IR light toward the front surface and to receive, through the display front surface, IR light scattered by the object.

In some implementations, the FSC display may include a processor. The light modulators may be switched in accordance with a first modulation scheme to render an image. The light sensor may be configured to output, to the processor, a signal representative of a characteristic of the received, redirected light. The processor may be configured to switch the light modulators in accordance with a second modulation scheme to selectively pass object illuminating light through at least one of the respective apertures, the object illuminating light being at least partially unrelated to the image; and recognize, from the output of the light sensor, a characteristic of the object.

Another innovative aspect of the subject matter described in this disclosure can be implemented in a method that includes switching, with a processor, one or more of a plurality of light modulators. A field sequential color (FSC) display has a display front surface including a viewing area, the FSC display including a transparent substrate, a display lighting system, at least one light sensor, and the plurality of light modulators. Each light modulator includes a shutter assembly configured as a micro electromechanical (MEM) device disposed proximate to a rear surface of the transparent substrate. Each light modulator is configured to be switched between an open position that permits transmittance of light from the display lighting system through a respective aperture to the front surface and a shut position that blocks light transmission through the respective aperture. The transparent substrate is disposed substantially parallel to the front surface and between the display backlight system and the front surface. The light modulators are switched in accordance with a first modulation scheme to render an image, and in accordance with a second modulation scheme to selectively pass object illuminating light through at least one of the respective apertures, the object illuminating light being at least partially unrelated to the image. The transparent substrate is configured to pass light emitted by the display lighting system toward the display front surface and to receive light reflected through the display front surface from an object. The at least one light sensor is disposed within the viewing area and proximate to the rear surface of the transparent substrate. The method further includes outputting, from the light sensor to the processor, a signal representative of a characteristic of the received, redirected light; switching the light modulators in accordance with a second modulation scheme to selectively pass object illuminating light through at least one of the respective apertures, the object illuminating light being at least partially unrelated to the image, and recognizing, with the processor, from the output of the light sensor, a characteristic of the object.

Details of one or more implementations of the subject matter described in this specification are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1A shows a block diagram of an example of an electronic device having an electronic display.

FIG. 1B and FIG. 1C show an example of an arrangement including a transparent substrate and a light sensor.

FIG. 2 illustrates a schematic diagram of an example of an arrangement for spatial light modulation of an interactive display.

FIG. 3 is a cross sectional view of an electronic display incorporating a light modulation array.

FIG. 4 illustrates an example of an interactive display according to an implementation.

FIG. 5 illustrates a further example of an interactive display, according to a further implementation.

FIG. 6 illustrates a yet further example of an interactive display, according to another implementation.

FIG. 7 illustrates a further example of an interactive display, according to an implementation.

FIG. 8 illustrates an example of a scanning pattern for a second modulation scheme in accordance with some implementations.

FIG. 9 illustrates a further example of a scanning pattern for a second modulation scheme in accordance with some implementations.

FIG. 10 illustrates an example of an interactive display, configured for document scanning, according to an implementation.

FIG. 11 illustrates an example of an interactive display, configured for document scanning, according to a further implementation.

FIG. 12 illustrates an example of a process flow recognizing a characteristic of an object with an FSC display according to an embodiment.

Like reference numbers and designations in the various drawings indicate like elements.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. The described implementations may be implemented in any device or system that can be configured to display an image, whether in motion (e.g., video) or stationary (e.g., still image), and whether textual, graphical or pictorial. More particularly, it is contemplated that the described implementations may be included in or associated with a variety of electronic devices such as, but not limited to: mobile telephones, multimedia Internet enabled cellular telephones, mobile television receivers, wireless devices, smartphones, Bluetooth® devices, personal data assistants (PDAs), wireless electronic mail receivers, hand-held or portable computers, netbooks, notebooks, smartbooks, tablets, printers, copiers, scanners, facsimile devices, GPS receivers/navigators, cameras, MP3 players, camcorders, game consoles, wrist watches, clocks, calculators, television monitors, flat panel displays, electronic reading devices (i.e., e-readers), computer monitors, auto displays (including odometer and speedometer displays, etc.), cockpit controls and/or displays, camera view displays (such as the display of a rear view camera in a vehicle), electronic photographs, electronic billboards or signs, projectors, architectural structures, microwaves, refrigerators, stereo systems, cassette recorders or players, DVD players, CD players, VCRs, radios, portable memory chips, washers, dryers, washer/dryers, parking meters, packaging (such as in electromechanical systems (EMS), microelectromechanical systems (MEMS) and non-MEMS applications), aesthetic structures (e.g., display of images on a piece of jewelry) and a variety of EMS devices. The teachings herein also can be used in non-display applications such as, but not limited to, electronic switching devices, radio frequency filters, sensors, accelerometers, gyroscopes, motion-sensing devices, magnetometers, inertial components for consumer electronics, parts of consumer electronics products, varactors, liquid crystal devices, electrophoretic devices, drive schemes, manufacturing processes and electronic test equipment. Thus, the teachings are not intended to be limited to the implementations depicted solely in the Figures, but instead have wide applicability as will be readily apparent to one having ordinary skill in the art.

Described herein below are new techniques for an interactive display with improved user input/output functionality. In some implementations, a gesture-responsive user input/output (I/O) interface for an electronic device is provided. “Gesture” as used herein broadly refers to a gross motion of a user's hand, digit, or hand-held object, or other object under control of the user. The motion may be made proximate to, but not necessarily in direct physical contact with, the electronic device. In some implementations, the electronic device senses and reacts in a deterministic way to a user's gesture. In some implementations, a document scanning capability is provided.

Particular implementations of the subject matter described in this disclosure can be implemented to realize one or more of the following potential advantages. The presently disclosed techniques provide a significant improvement in touch and/or gesture I/O using an interactive field sequential color (FSC) display. The FSC display includes an array of light modulators configured to be individually switched between an open position that permits transmittance of light through a respective aperture and a shut position that blocks light transmission through the respective aperture. The interactive FSC display includes a transparent substrate, such as a glass or other transparent material, which has a rear surface proximate to which light sensors or other photo-sensitive elements are disposed. The interactive FSC display is configured to determine the location and/or relative motion of a user's touch or gesture proximate to the display, and/or to register an image of the object.

Particular implementations of the subject matter described in this disclosure can be implemented to realize one or more of the following potential advantages. The user's gesture may occur over a “full range” of view with respect to the interactive display. By “full range” is meant that the gesture may be recognized, at a first extreme, even when made very close to, or in physical contact with, the interactive display; in other words, “blind spots” exhibited by prior art camera systems are avoided. At a second extreme, the gesture may be recognized at a substantial distance, up to approximately 500 mm, from the interactive display, which is not possible with known projective capacitive systems. The above functionality may be provided by configuring the transparent substrate with light turning sensors, thereby avoiding the cost and thickness associated with adding an additional light-guide layer. Because the shutter aperture area of an FSC display is a relatively small fraction of a total viewing area of the FSC display, a significant portion of the transparent substrate may be occupied by the light sensors without any appreciable quality degradation of a displayed image.

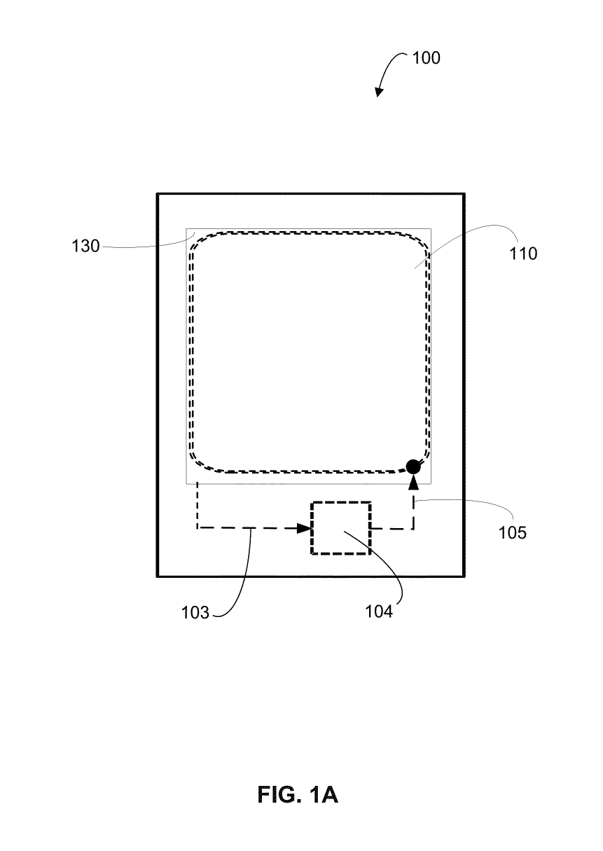

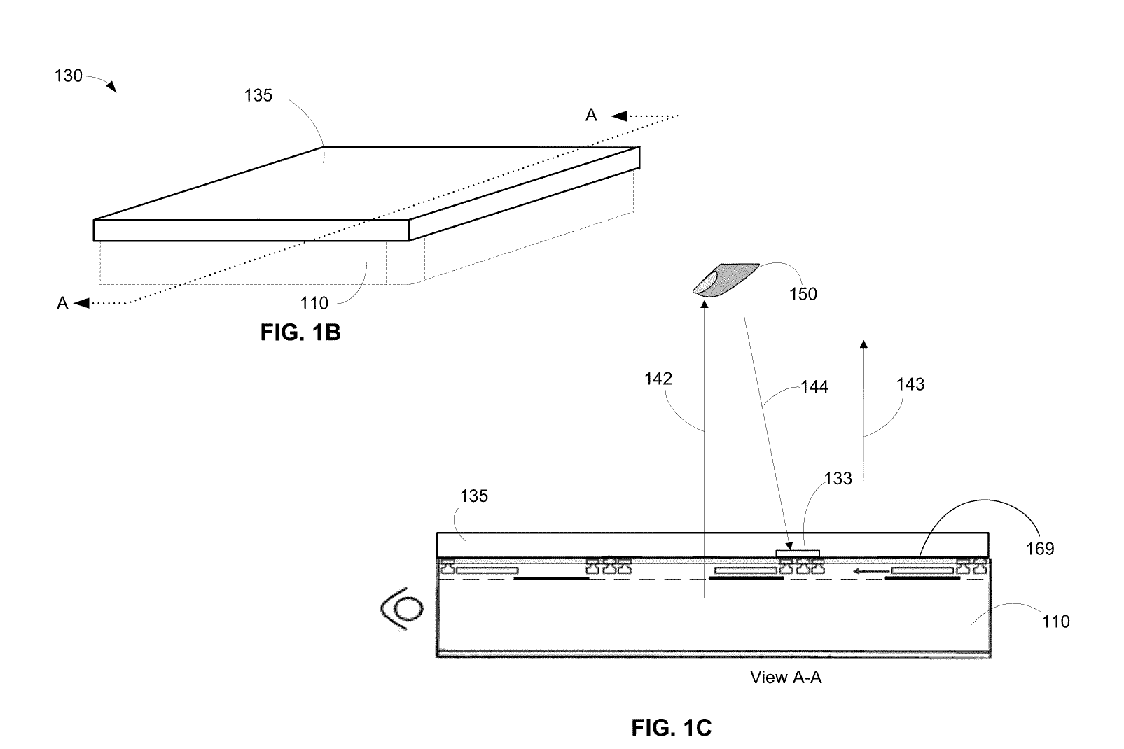

FIG. 1A shows a block diagram of an example of an electronic device having an interactive display according to an implementation. An apparatus 100, which may be, for example, a personal electronic device (PED), may include an electronic display 110 and a processor 104. The electronic display 110 may be a touch screen display, but this is not necessarily so. In some implementations, the processor 104 may be configured to control an output of the electronic display 110, or an electronic device (not shown) communicatively coupled with apparatus 100. The processor 104 may control the output of the electronic display 110 in response, at least in part, to a user input. The user input may include a touch or a gesture, where the user gesture may include, for example, a gross motion of a user's appendage, such as a hand or a finger, or a handheld object or the like. The gesture may be located, with respect to the electronic display 110, at a wide range of distances. For example, a gesture may be made proximate to, or even in direct physical contact with the electronic display 110. Alternatively, the gesture may be made at a substantial distance, up to, approximately 500 mm from the electronic display 110. In some implementations, the processor 104 may be configured to collect and process data received from the electronic display 110 regarding the user input. The data may include a characteristic of a touch, gesture, or object related to the user input. The characteristic may include location and motion information of a touch or a gesture, or image data, for example.

An arrangement 130 (examples of which are described and illustrated herein below) may be disposed substantially parallel to a front surface of the electronic display 110. In an implementation, the arrangement 130 may be substantially transparent and optically coupled to the electronic display 110, such that at least most light emitted by a display lighting system (not shown) of the electronic display 110 is transmitted through the arrangement 130. The arrangement 130 may output one or more signals responsive to light received from the display lighting system and/or a source exterior to the electronic display 110. In some implementations, the signals may be responsive to light reflected into the arrangement 130 from a user's appendage, an object or a document, for example.

In some implementations, signals outputted by the arrangement 130, via a first signal path 103, may be analyzed by the processor 104 so as to recognize an instance of a user input, such as a touch or a gesture. The processor 104 may then control the electronic display 110, responsive to the user input, by way of signals sent to the electronic display 110 via a second signal path 105. In some implementations, signals outputted by the arrangement 130, via the first signal path 103, may be analyzed so as to obtain image data.

FIG. 1B and FIG. 1C show an example of an arrangement including a transparent substrate and a light sensor. In the illustrated implementation, the arrangement 130 includes a transparent substrate 135 and a light sensor 133. Referring now to FIG. 1B, which may be referred to as a perspective view, the arrangement 130 is illustrated as being disposed above and substantially parallel to an upper surface of the electronic display 110. In the illustrated implementation, the perimeter of the transparent substrate 135 is substantially coextensive with the perimeter of the electronic display 110.

Although one light sensor 133 is shown in the illustrated implementation, it will be appreciated that numerous other arrangements are possible. Any number of light sensors may be used. In some implementations, the light sensor 133 may be disposed above or below the transparent substrate 135. The light sensor 133 may include one or more photosensitive elements, such photodiodes, phototransistors, charge coupled device (CCD) arrays, complementary metal oxide semiconductor (CMOS) arrays or other suitable devices operable to output a signal representative of a characteristic of detected visible light. The light sensor 133 may output signals representative of color of detected light, for example. In some implementations, the signals may also be representative of other characteristics, including intensity, polarization, directionality, frequency, amplitude, amplitude modulation, and/or other properties.

The transparent substrate 135 may be optically coupled to the electronic display 110. The transparent substrate 135 may be substantially transparent such that at least most light 143 from the electronic display 110 passes through the transparent substrate 135 and may be observed by a user (not illustrated).

The transparent substrate 135 may include a substantially transparent, relatively thin, overlay disposed on, or proximate to, the front surface of the electronic display 110. Advantageously, the transparent substrate 135, which may also be referred to herein as a top glass or MEMS glass, may be a substantially transparent material, such as a glass, having a rear surface 169 proximate to which components of electronic display 110 may be disposed. For example, a thin film transistor (TFT) layer, shutters, and associated microelectromechanical (MEM) components, as described in more detail hereinbelow may be disposed on or behind the rear surface 169.

In some implementations, for example, the transparent substrate 135 may be approximately 0.5 mm thick, while having a planar area in an approximate range of tens or hundreds of square centimeters.

As illustrated in FIG. 1C, when an object 150 interacts with light 142 (which may be referred to herein as “object illuminating light”) from the electronic display 110, scattered light 144, resulting from the interaction, may be directed toward the transparent substrate 135 and be received by light sensor 133. The object 150 may be, for example, a user's appendage, such as a hand or a finger, or it may be any physical object, hand-held or otherwise under control of the user, including a document to be imaged, but is herein referred to, for simplicity, as the “object.”

The light sensor 133 may be configured to detect one or more characteristics of the scattered light 144, and output, to the processor 104, a signal representative of the detected characteristics. For example, the characteristics may include intensity, directionality, frequency, amplitude, amplitude modulation, and/or other properties.

Referring again to FIG. 1A, the processor 104 may be configured to receive, from the light sensor 133, signals representative of the detected characteristics, via the first signal path 103. The processor 104 may be configured to recognize, from the output signals of the light sensor 133, an instance of a user gesture. Moreover, the processor 104 may control one or more of the electronic display 110, other elements of the apparatus 100, and/or an electronic device (not shown) communicatively coupled with apparatus 100. For example, an image displayed on the electronic display 110 may be caused to be scrolled up or down, rotated, enlarged, or otherwise modified. In addition, the processor 104 may be configured to control other aspects of the apparatus 100, responsive to the user gesture, such as, for example, changing a volume setting, turning power off, placing or terminating a call, launching or terminating a software application, etc.

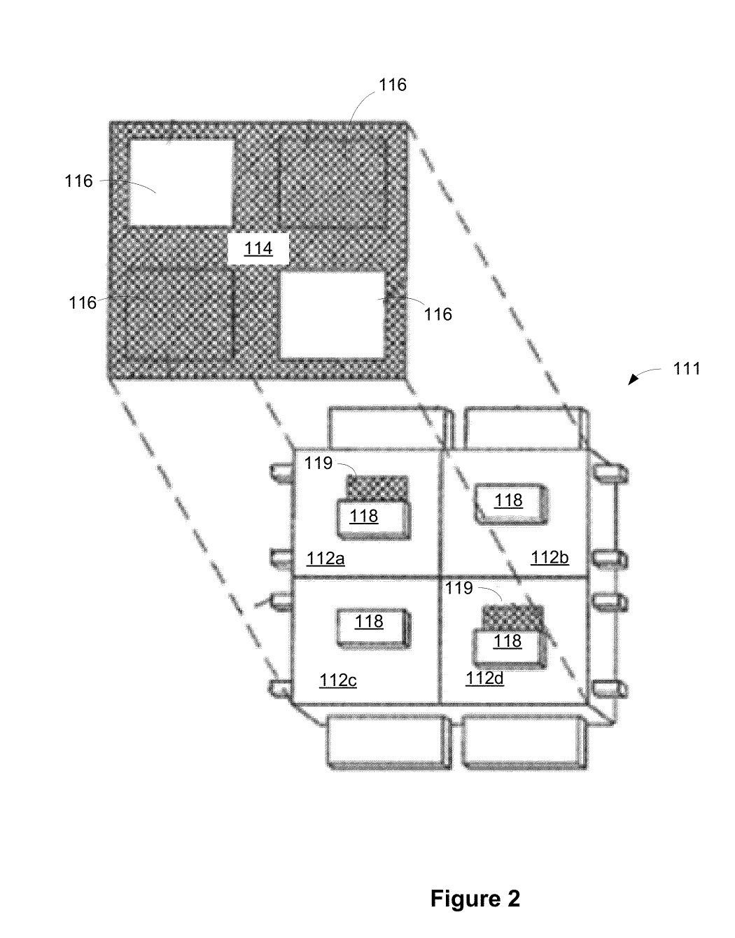

The electronic display 110 may include an arrangement for spatial light modulation. FIG. 2 illustrates a schematic diagram of an example of an arrangement for spatial light modulation of an interactive display. The arrangement 111 (which may be referred to as the “light modulation array”) may include a plurality of light modulators 112a-112d (generally, “light modulators 112”) arranged in rows and columns.

Each light modulator 112 may include a corresponding aperture 119. Each light modulator 112 may also include a corresponding shutter 118, or another means to switch the corresponding aperture 119 between an open position and a shut position. In order to render an image 114, the electronic display 110 may be configured to switch the light modulators in a time domain in accordance with a particular modulation scheme (the “first modulation scheme”). For example, to illuminate a pixel 116 of the image 114, a shutter 118 corresponding to the pixel is in an open position that permits transmittance of light from a display lighting system (not illustrated) through the corresponding aperture 119 toward a viewer (not illustrated). To keep the pixel 116 unlit, the corresponding shutter 118 is positioned such that it blocks light transmission through the corresponding aperture 119. Each aperture 119 may be defined by an opening provided in a reflective or light-absorbing layer, for example.

In the illustrated configuration, light modulators 112a and 112d are switched to an open position, whereas light modulators 112b and 112c are switched to a shut position. As a result of selectively switching the positions of the light modulators 112a-112d in accordance with the first modulation scheme, the electronic display 110 may render the image 114, as describe in more detail herein below. In some implementations, the first modulation scheme may be controlled by a computer processing arrangement that may be part of or may be communicatively coupled with the processor 104.

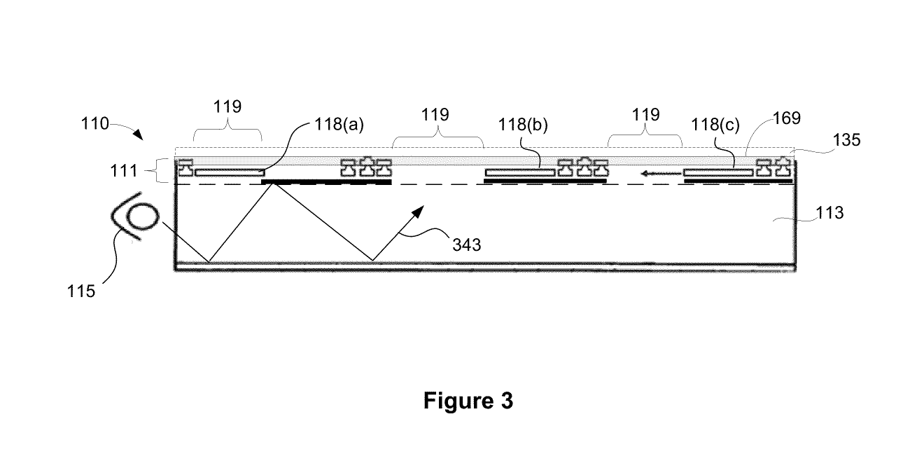

FIG. 3 is a cross sectional view of an interactive display incorporating a light modulation array. The electronic display 110 includes the light modulation array 111, an optical cavity 113, and a display lighting system 115. The light modulation array 111 may include any number of light modulators 112, as described hereinabove and illustrated in FIG. 2. As shown in the implementation illustrated in FIG. 3, each light modulator may include a corresponding shutter 118 and be configured to be switched between an open position and a shut position. In the illustrated implementation, for example, the shutters 118(b) and 118(c) are depicted in the open position, whereas, the shutter 118(a) is depicted in the closed position. Advantageously, the light modulators may be disposed on or proximate to the rear surface 169 of the transparent substrate 135.

In some implementations, the optical cavity 113 may be formed from a light guide that may be about 300 microns to about 2 mm thick, for example. The display lighting system 115 may be configured to emit light 343 into the optical cavity 113. Advantageously, at least a portion of the light 343 may undergo TIR and be distributed substantially uniformly throughout the optical cavity 113 as a result of judicious placement of light scattering elements (not illustrated) on one or more surfaces enclosing the optical cavity 113. For example, some light scattering elements may be formed in or on the rear enclosure of the optical cavity 113 to aid in redirecting the light 343 through the apertures 119.

The electronic display 110 may be referred to as a field sequential color (FSC) display, because, in some implementations, images are rendered by operating the display lighting system 115 so as to sequentially alternate the color of visible light emitted by the display lighting system 115. For example, the display lighting system 115 may emit a sequence of separate flashes of red, green and blue light. Synchronized with the sequence of flashes, a sequence of respective red, green and blue images may be rendered by appropriate switching, in accordance with the first modulation scheme, of the light modulators 112 in the light modulation array 111 to respective open or shut positions.

As a result of the persistence of vision phenomenon, a viewer of rapidly changing images, for example, images changing at frequencies of greater than 20 Hz, may perceive an image which is the combination, or approximate average, of the images displayed within a particular period. In some implementations, the first modulation scheme may be adapted to utilize this phenomenon so as to render color images while using as few as a single light modulator for each pixel of a display.

For example, in a color FSC display, the first modulation scheme may include dividing an image frame to be displayed into a number of sub-frame images, each corresponding to a particular color component (for example, red, green, or blue) of the original image frame. For each sub-frame image, the light modulators of the display are set into states corresponding to the color component's contribution to the image. The light modulators then are illuminated by a light emitter of the corresponding color. The sub-images are displayed in sequence at a frequency (for example, greater than 60 Hz) sufficient for the brain to perceive the series of sub-frame images as a single image.

As a result, an FSC display may require only a single light modulator per pixel, instead of a pixel requiring a separate spatial light modulator for each of three or more color filters. Advantageously, an FSC display may not suffer a loss of power efficiency due to absorption in a color filter and may make maximum use of the color purities available from modern light emitting diodes (LEDs), thereby providing a range of colors exceeding those available from color filters, i.e. a wider color gamut.

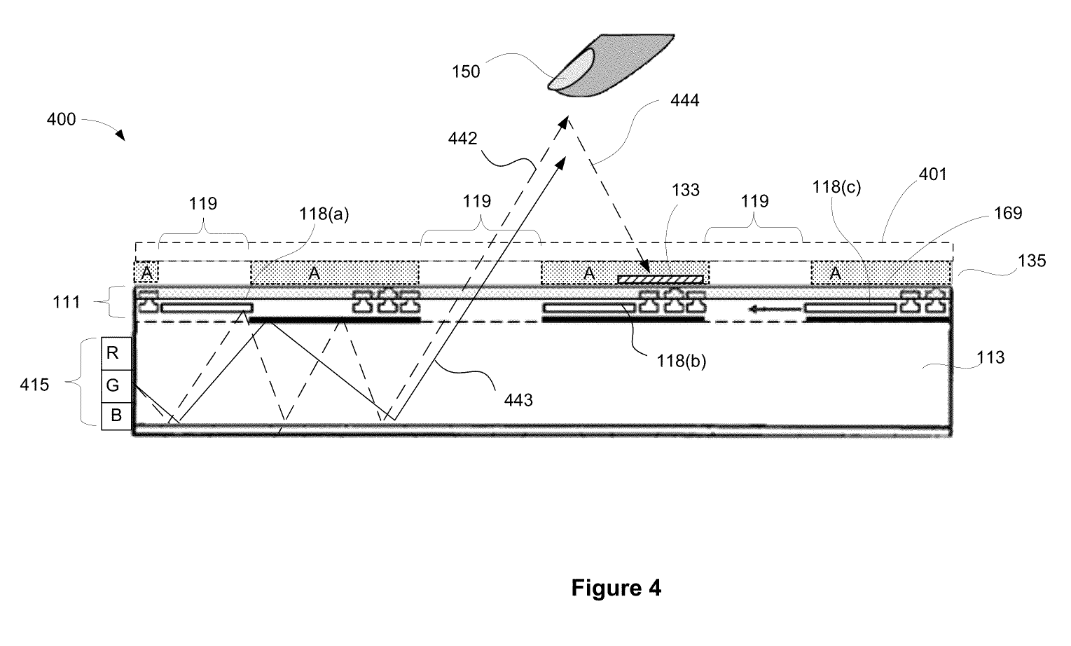

FIG. 4 illustrates an example of an interactive display according to an implementation. In the illustrated implementation, an interactive FSC display 400 includes a front surface 401, the transparent substrate 135, the light sensor 133, the light modulation array 111, the optical cavity 113 and a display lighting system 415. The interactive FSC display 400 may be configured to render color images, visible to a user through the front surface 401, by sequentially flashing one or more wavelength specific light emitters of the display lighting system 415 into the optical cavity 113, while synchronously performing spatial light modulation according to the first modulation scheme. In the illustrated implementation, the display lighting system 415 includes three wavelength specific light emitters, designated R (red), B (blue) and G (green). It will be appreciated, however, that other arrangements of wavelength specific light emitters are possible. For example, in addition to, or instead of one or more of the RGB light emitters, light emitters of white, yellow, or cyan color may be included in the display lighting system 415.

In the illustrated implementation, the display lighting system 415 is a backlight, however implementations including only a frontlight or both a frontlight and a backlight are within the contemplation of the present disclosure.

The light modulation array 111 may include an array of light modulators as described hereinabove. As shown in the illustrated implementation, each light modulator may include corresponding shutter 118 and be configured to be switched between an open position and a shut position. For example, in the illustrated implementation, the shutters 118(a) and 118 (c) are each in the open position, and the shutter 118(b) is in the closed position. Advantageously, the light modulators may be disposed on or proximate to the rear surface 169 of the transparent substrate 135.

In some implementations, the transparent substrate 135 may be disposed between the display lighting system 415 and the front surface 401. Advantageously, the transparent substrate 135 may be disposed between the light modulation array 111 and the front surface 401. The transparent substrate 135 may be substantially parallel to the front surface 401. In some implementations, the transparent substrate 135 may have a periphery at least coextensive with a viewing area of the interactive FSC display 400.

As illustrated in FIG. 4, when the object 150 interacts with object illuminating light 442, scattered light 444, resulting from the interaction, may be directed toward the transparent substrate 135 and be received by light sensor 133. The object 150 may be, for example, a user's appendage, such as a hand or a finger, or it may be any physical object, hand-held or otherwise under control of the user, including a document to be imaged, but is herein referred to, for simplicity, as the “object.”

The light sensor 133 may be configured to detect one or more characteristics of the scattered light 144, and output, to a processor (not illustrated), a signal representative of the detected characteristics. For example, the characteristics may include intensity, directionality, frequency, amplitude, amplitude modulation, and/or other properties.

Although a single light sensor 133 is illustrated in FIG. 4, it will be appreciated that any number of light sensors 133 may be contemplated. Advantageously, light sensors 133 may be selectively located in areas not directly above the pixel apertures, e.g. in regions ‘A’ of the transparent substrate 135. Advantageously, because the shutter aperture area of an FSC display is a relatively small fraction (e.g., one tenth to one half) of a total viewing area of the interactive FSC display 400, a significant portion of the transparent substrate 135 may be occupied by one or more light sensors 133 without any appreciable quality degradation of a displayed image. In various implementations contemplated by the present disclosure, the number of light sensors may range from about four light sensors to some thousands of light sensors, for example.

In some implementations, there may be one or more optical components disposed between the transparent substrate 135 and the light sensor 133. For example, a holographic or diffractive grating, an aperture array, a mask, a lens, a lens array, or another method of focusing light, increasing efficiency, or better discriminating angular versus spatial information for the scattered light 444 may be provided.

Spatial light modulation may be performed to produce a rendered image by switching a selected subset of the shutters 118 to an open position in accordance with the first modulation scheme. In some implementations, switching of the shutters 118 may be performed in synchronization with sequential flashing of the one or more wavelength specific light emitters of the display lighting system 415.

For example, a green wavelength specific light emitter of the display lighting system 415 may be configured to emit light 443 (“image rendering light”) into the optical cavity 113. Advantageously, at least a portion of the image rendering light 443 may undergo TIR and be distributed substantially uniformly throughout the optical cavity 113. A portion of the image rendering light 443 may be transmitted through one or more of the apertures 119 and contribute to the rendered image.

In the illustrated implementation, the green light emitter of the display lighting system 415 is also configured to emit the object illuminating light 442 into the optical cavity 113. At least a portion of the object illuminating light 442 may undergo TIR and be distributed substantially uniformly throughout the optical cavity 113.

It should be noted that, in the illustrated implementation, the object illuminating light 442 and the image rendering light 443 are depicted as geometrically different ray traces only for clarity of illustration, and that the primary distinction between the object illuminating light 442 and the image rendering light 443 is temporal and/or spectral, rather than spatial. In the illustrated implementation, for example, where the image rendering light 443 and the object illuminating light 442 may have the same wavelength, the image rendering light 443 and the object illuminating light 442 may be emitted by the display lighting system 415 at different times, for example as part of different sub-frames. As a further example, the object illuminating light 442 may be visible light emitted during a document scanning operation during which the display viewing area is not ordinarily observable by a user.

In some implementations, the object illuminating light 442 may be light of a different wavelength than the image rendering light 443. For example, the object illuminating light 442 may be of a nonvisible wavelength such as infrared (IR) or near IR. In such implementations, temporal separation between the object illuminating light 442 and the image rendering light 443 may or may not also be provided.

The present inventors have appreciated that an optical touch and gesture recognition functionality, as well as a document scanning capability, may be provided by using the object illuminating light 442. More particularly, light modulators may be switched in accordance with a second modulation scheme to selectively pass the object illuminating light 442 through at least one of the respective apertures, the object illuminating light 442 being at least partially unrelated to the rendered image. In some implementations, a document scanning capability may also be provided by substantially similar hardware.

Advantageously, the second modulation scheme may provide that the object illuminating light 442 is passed only when there is one or both of temporal separation and spectral separation with respect to the image rendering light 443. In some implementations, the second modulation scheme may provide for interspersing of sub-frames during which the object illuminating light 442 is passed with sub-frames during which the image rendering light 443 is passed. For example, where the object illuminating light 442 is at an IR wavelength, and the image rendering light 443 is passed in a series of groups of sub-frames of visible red, green and blue image patterns, the second modulation scheme may provide that an IR emitter is flashed between each group of sub-frames. In some implementations a group of sub-frames may include ten sub-frames each of visible red, green and blue image patterns, for example.

In some implementations, the second modulation scheme may provide, periodically, a “blank” sub-frame, during which the display lighting system is caused to turn off all light sources. During such a blank sub-frame, a level of ambient light proximate to the interactive FSC display 400 may be determined, for example. In some implementations, the light sensors may be configured to sense the pattern of shadows cast by an object 150 on the FSC display 400 during such blank sub-frames. The shutters for all the pixels may be closed during such blank sub-frames, in some implementations.

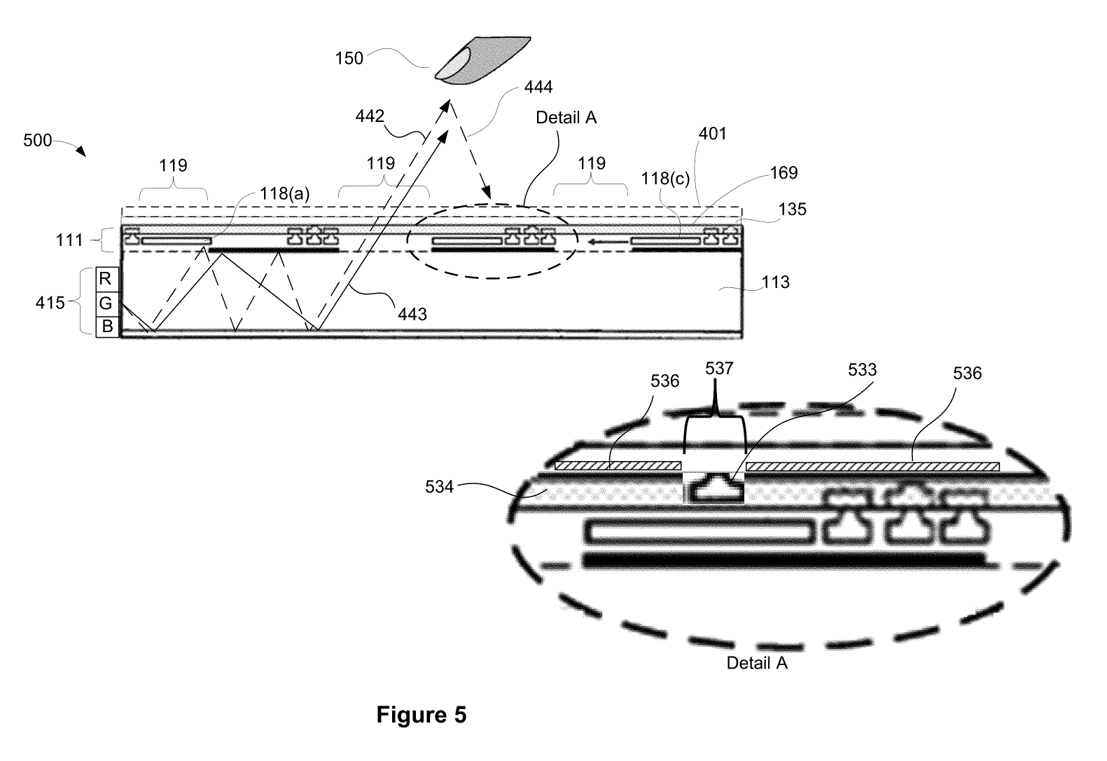

FIG. 5 illustrates an example of an interactive display according to a further implementation. In the illustrated implementation, an interactive FSC display 500 includes the front surface 401, the transparent substrate 135, the light modulation array 111, the optical cavity 113 and a display lighting system 415 as described hereinabove. The interactive FSC display 500 also includes an arrangement for light sensing illustrated in Detail A. The arrangement includes a thin film transistor (TFT) photo sensor 533 disposed within a TFT layer 534. In some implementations, a masking layer 536 may be disposed on or above a front surface of the TFT layer 534. Appropriate openings in the masking layer 536 may be provided proximate to the TFT photo sensor 533 so as to provide a window 537 through which scattered light 444 may reach the TFT photo sensor 533. The window 537 may include a region wherein masking layer 536 is omitted. In some implementations, the window may include a transparent material or a material configured to transmit light in a selected range of wavelengths.

In some implementations a light directing layer (not illustrated) may be disposed on or above the photo sensor 533. For example, the light directing layer may include hole apertures, transmission diffraction gratings, surface holograms or volume holograms. One or more of such elements may be optimized to transmit light of a selected range of wavelengths, such as, for example infrared light. One or more of such elements may also be configured to transmit light received only from a selected range of incidence angles, for example, and may reflect scatter or absorb light of other wavelengths and/or incidence angles.

In some implementations, the second modulation scheme may provide, periodically, a “blank” sub-frame, during which the display lighting system is caused to turn off all light sources. During such a blank sub-frame, a level of ambient light proximate to the interactive FSC display 500 may be determined, for example. In some implementations, the light sensors may be configured to sense the pattern of shadows cast by an object 150 on the FSC display 500 during such blank sub-frames. The shutters for all the pixels may be closed during such blank sub-frames, in some implementations.

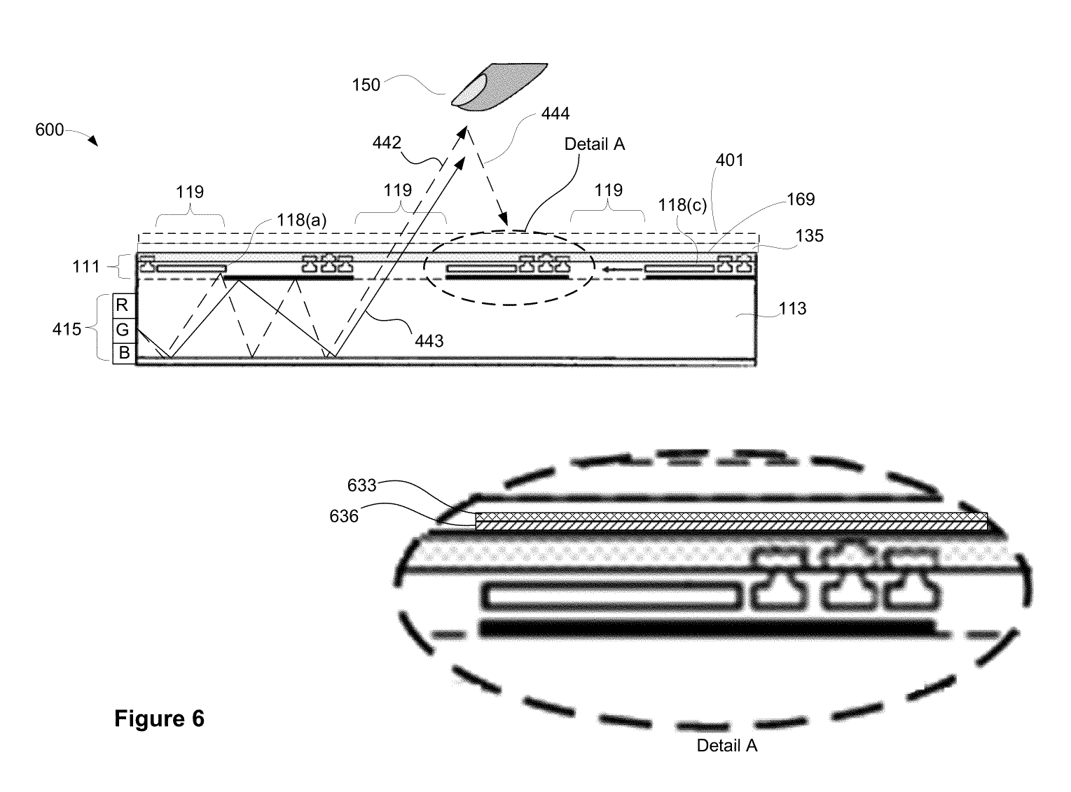

FIG. 6 illustrates an example of an interactive display according to another implementation. In the illustrated implementation, an interactive FSC display 600 includes the front surface 401, the transparent substrate 135, the light modulation array 111, the optical cavity 113 and a display lighting system 415 as described hereinabove. The interactive FSC display 600 also includes an arrangement for light sensing illustrated in Detail A. The arrangement includes a photosensor layer 633 disposed on or above a masking layer 636. The photosensor layer 633 may include photosensitive material deposited on transparent substrate 535, for example. In some implementations the photosensitive material may be or include an organic or inorganic material, including a semiconductor, such as silicon or silicon-germanium.

In some implementations a light directing layer (not illustrated) may be disposed on or above the photosensor layer 633. For example, the light directing layer may include hole apertures, transmission diffraction gratings, surface holograms or volume holograms. One or more of such elements may be optimized to transmit light of a selected range of wavelengths, such as, for example infrared light. One or more of such elements may also be configured to transmit light received only from a selected range of incidence angles, for example, and may reflect scatter or absorb light of other wavelengths and/or incidence angles.

In some implementations, the second modulation scheme may provide, periodically, a “blank” sub-frame, during which the display lighting system is caused to turn off all light sources. During such a blank sub-frame, a level of ambient light proximate to the interactive FSC display 600 may be determined, for example. In some implementations, the light sensors may be configured to sense the pattern of shadows cast by an object 150 on the FSC display 600 during such blank sub-frames. The shutters for all the pixels may be closed during such blank sub-frames, in some implementations.

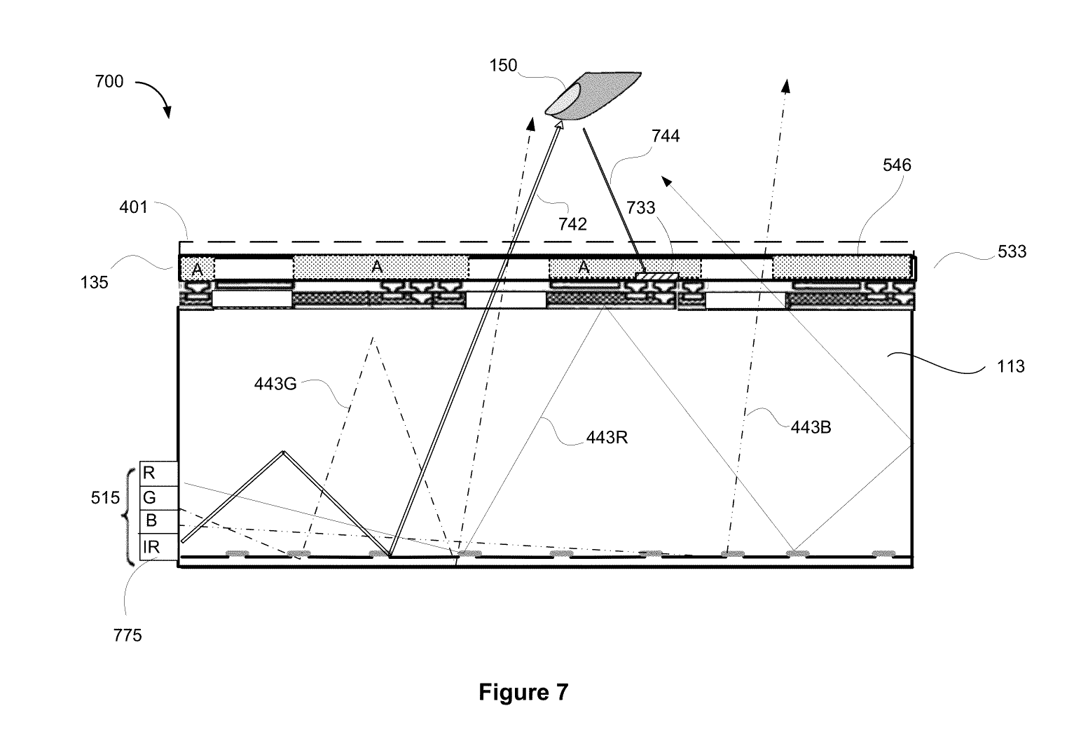

FIG. 7 illustrates a further example of an interactive display, according to an implementation. In the illustrated implementation, the interactive FSC display 700 includes an IR emitter 775 that may be configured to emit IR light into the optical cavity 113. Emitted IR light 742 may strike the object 150 and be scattered back toward the front surface 401. The object may be on or above the front surface 401. Scattered IR light 744 resulting from interaction of the emitted IR light 742 with the object 150 may be received by IR sensor 733. The IR sensor 733 may be configured to output, to a processor (not shown), a signal representative of a characteristic of scattered IR light 744. The processor may be configured to recognize, from the output of the IR sensor 733, the characteristic of the object 150.

In some implementations, a wavelength of the IR light may be within a range that inexpensive silicon detectors may detect (700 nm to 1000 nm wavelength, for example).

In some implementations, the light sensor may be selectively located in an area not directly above the pixel apertures, e.g. in a region ‘A’ of the transparent substrate 135. Advantageously, because the shutter aperture area of an FSC display is a relatively small fraction (e.g., one tenth to one half) of a total viewing area of the interactive FSC display 700, a significant portion of the transparent substrate 135 may be occupied by one or more light sensors 733 without any appreciable quality degradation of a displayed image.

In some implementations, the second modulation scheme may provide, periodically, a “blank” sub-frame, during which the display lighting system is caused to turn off all light sources. During such a blank sub-frame, a level of ambient light proximate to the interactive FSC display 700 may be determined, for example. In some implementations, the light sensors may be configured to sense the pattern of shadows cast by an object 150 on the FSC display 700 during such blank sub-frames. The shutters for all the pixels may be closed during such blank sub-frames, in some implementations.

As indicated above, outputs of the IR sensor 733 may indicate one or more characteristics of the object 150. Such characteristics include location, motion, and image characteristics of the object 150. Particular implementations for obtaining location and motion characteristics, which may relate to a user input including a touch or a gesture, are described hereinbelow. In such implementations, the second modulation scheme may include selectively opening of light modulators according to one or more scanning patterns. In order to provide a better understanding of features and benefits of the presently disclosed techniques, illustrative examples of scanning patterns will now be described.

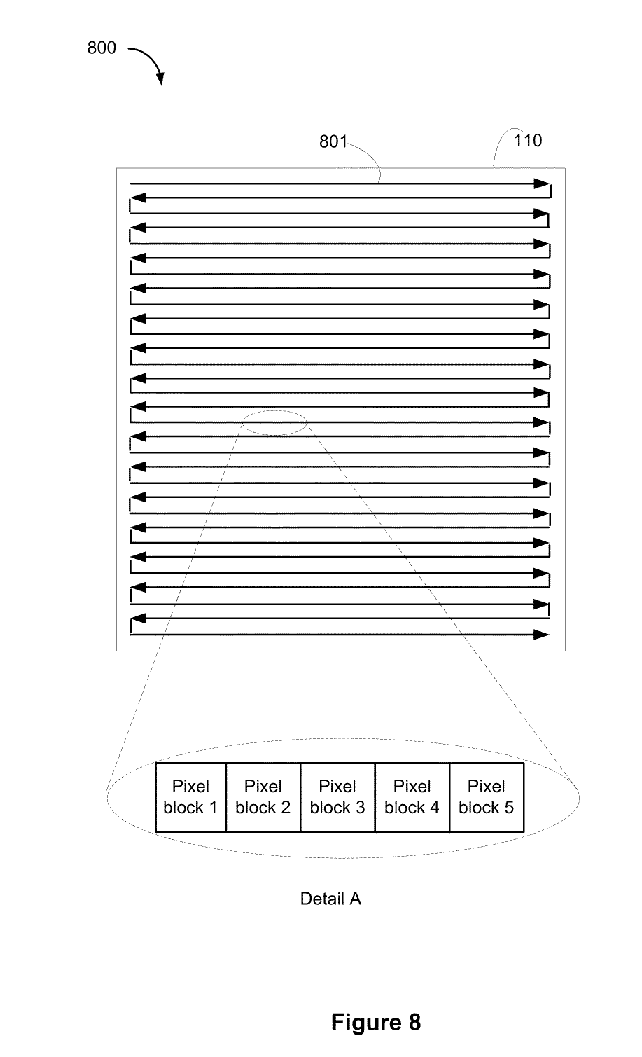

In some implementations, a scanning pattern may resemble a raster scan. FIG. 8 illustrates an example of a scanning pattern for a second modulation scheme in accordance with some implementations. In the illustrated arrangement 800, the second modulation scheme includes selectively switching of light modulators to the open position in a temporal sequence according to a scanning pattern 801. As a result, object illuminating light may be passed sequentially through a series of apertures, or blocks of apertures according to the scanning pattern 801, where each aperture is associated with a respective pixel. As a result, substantially all of the viewing area of the electronic display 110 may be encompassed by the scanning pattern 801.

In some implementations, a raster scan line may be composed of a series of adjacent apertures. However, taking into account that apertures are typically much smaller in size than the object 150, it may be advantageous to scan blocks of apertures. For example, referring to Detail A, each pixel block may include multiple apertures and be approximately one to 25 square millimeters in size. Two or more blocks in a successive series of blocks of apertures may include at least some apertures in common. That is, in some implementations, there may be an overlap of apertures between a first block of apertures and a second, succeeding or preceding block of pixels.

It will be appreciated that the illustrated scanning pattern 801 is only an illustrative aspect of a feature of the second modulation scheme. Other scanning patterns are within the contemplation of the present disclosure. For example, a spiral scanning pattern may be implemented.

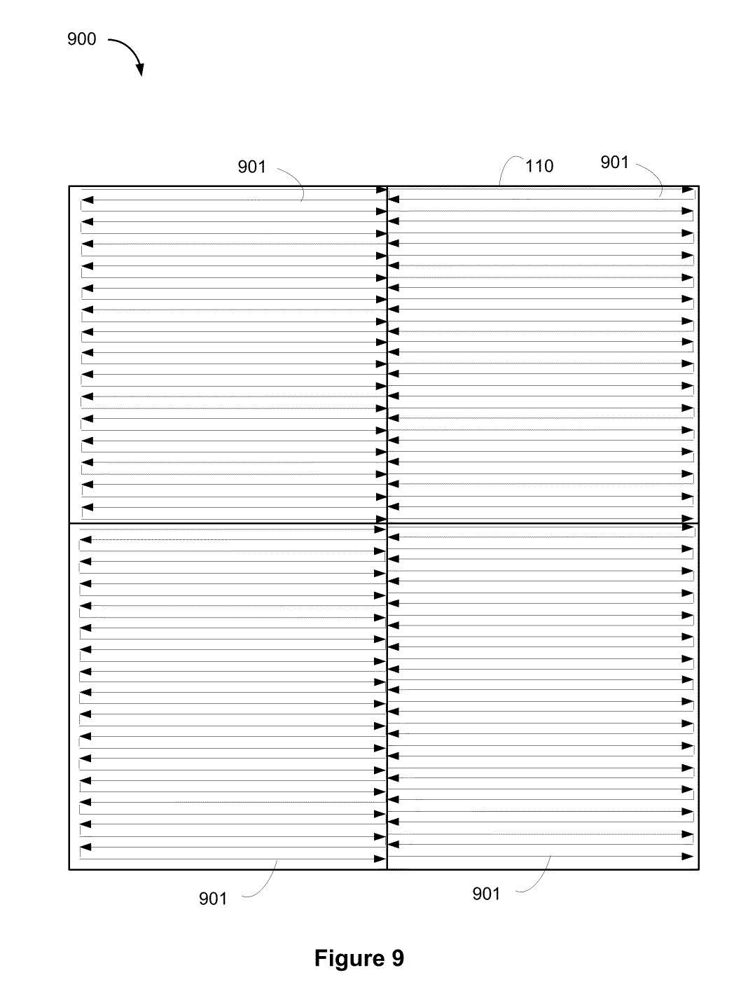

FIG. 9 illustrates a further example of a scanning pattern for a second modulation scheme in accordance with some implementations. In such implementation, a total viewing area of the electronic display 110 is treated as separate regions, with each separate region being separately scanned. In the illustrated implementation 900, for example, the total viewing area of the electronic display 110 is treated as four separate quadrants. Scanning of each region by way of a scanning pattern 901 may be performed, advantageously, in parallel. As a result, in each sub-frame in which object illuminating light is to be emitted through an open aperture, at least one aperture of a respective scanning pattern in each quadrant may be switched to an open position. Although in the illustrated implementation, a similar scanning pattern 901 is executed in four similarly sized quadrants, it will be appreciated that other arrangements are within the contemplation of the present disclosure. One or more the separate regions may be of a different size, for example. As a further example, a scanning pattern for any region may be different from a scanning pattern region for another region.

It will be appreciated that selectively switching of light modulators to the open position in a temporal sequence according to a scanning pattern as described above may be performed in synchronization with flashes of one or more wavelength specific light emitters of the display lighting system 415. Referring again to FIG. 7, blocks of light modulators may be switched to the open position sequentially according to the scanning, in synchronization with flashes of IR emitter 775, for example. In the illustrated implementation a display lighting system 515 included the IR emitter 775, but this is not necessarily so.

When the object 150 is approximately above a block of light modulators switched to the open position, the object 150 will interact with the emitted IR light 742. The scattered light 744 resulting from interaction of the emitted IR light 742 with the object 150 may be received by the IR sensor 733. The IR sensor 733 may be configured to output, to a processor (not shown), a signal representative of a characteristic of the received, redirected scattered light 546. The processor may be configured to recognize, from the output of the IR sensor 733, the characteristic of the object 150, such as location and relative motion, for example.

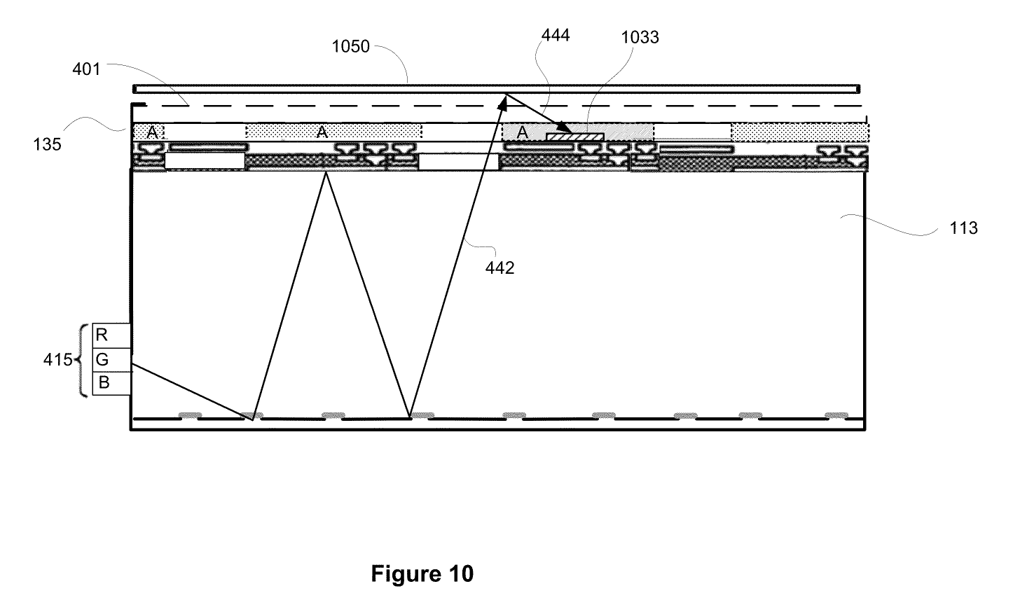

In some implementations, documents or objects proximate to the display may be scanned using visible light. FIG. 10 illustrates an example of an interactive display, configured for document scanning, according to an implementation. In the illustrated implementation, it is shown how a color scan may be performed on an object or document 1050 that is proximate to the front surface 401. The object or document 1050 may be scanned by sequentially flashing RGB light emitters of the display lighting system 415, and taking a separate light sensor reading for each illumination sub-frame using a visible (white) light sensor 1033.

For example, referring still to FIG. 10, the green light emitter of the display lighting system 415 may be configured to emit the object illuminating light 442 into the optical cavity 113. At least a portion of the object illuminating light 442 may undergo TIR and be distributed substantially uniformly throughout the optical cavity 113.

At least a portion of the object illuminating light 442 may be transmitted through a light modulator switched to the open position, and interact with the object or document 1050. Scattered light 444 resulting from the interaction may be received by visible light sensor 1033 via the transparent substrate 135. For clarity of illustration, FIG. 10 shows only a single color of light being emitted through a single aperture. Consistent with the techniques disclosed hereinabove however, a temporal sequence of light emissions may be sequentially flashed by each of, for example, the RGB light emitters of the display lighting system 415. Moreover, the presently disclosed document scanning technique may be performed in conjunction with performing the second modulation scheme that includes selectively opening of light modulators according to one or more scanning patterns.

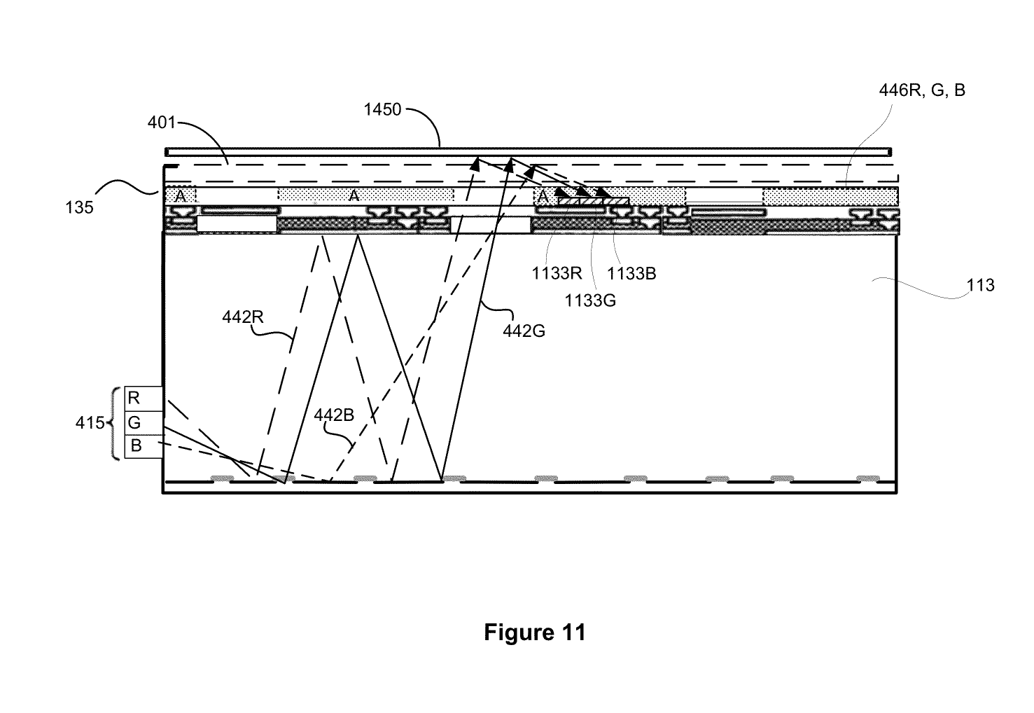

In some implementations, the RGB light emitters of the display light system 415 may be simultaneously illuminated. FIG. 11 illustrates an example of an interactive display, configured for document scanning, according to a further implementation. In the illustrated implementation, it is shown how a color scan may be performed on the object or document 1450 that is proximate to the front surface 401. The object or document 1450 may be scanned by simultaneously flashed RGB light emitters of the display lighting system 415. In the illustrated implementation light sensor 1133 includes multiple photosensitive elements, each sensitized, by way of respective filters, for example, to an individual color. Each individual photosensitive element, for example, 1133R, 1133G and 1133B may output a separate signal reading for each illumination sub-frame.

At least a portion of the object illuminating light 442R, 442G, and 442B may be transmitted through a light modulator switched to the open position, and interact with the object or document 1450. Scattered light resulting from the interaction may be received by the light sensor 1833, including the individual light sensing elements 1133R, 1133G, and 1133B.

For clarity of illustration, FIG. 11 shows light being emitted only through a single aperture. Consistent with the techniques disclosed hereinabove however, the presently disclosed document scanning technique may be performed in conjunction with opening a subset of, or all of, the apertures, or it may be performed in conjunction with performing the second modulation scheme that includes selectively opening of light modulators according to one or more scanning patterns.

In any of the above-described implementations, the second modulation scheme may be configured such that, during a fraction of the sub-frames all the RGB and IR light turn-off, and the photo-sensitive elements may be configured to sense the pattern of shadows cast by object 250 on the display. For this measurement, the shutters for all the pixels may be closed.

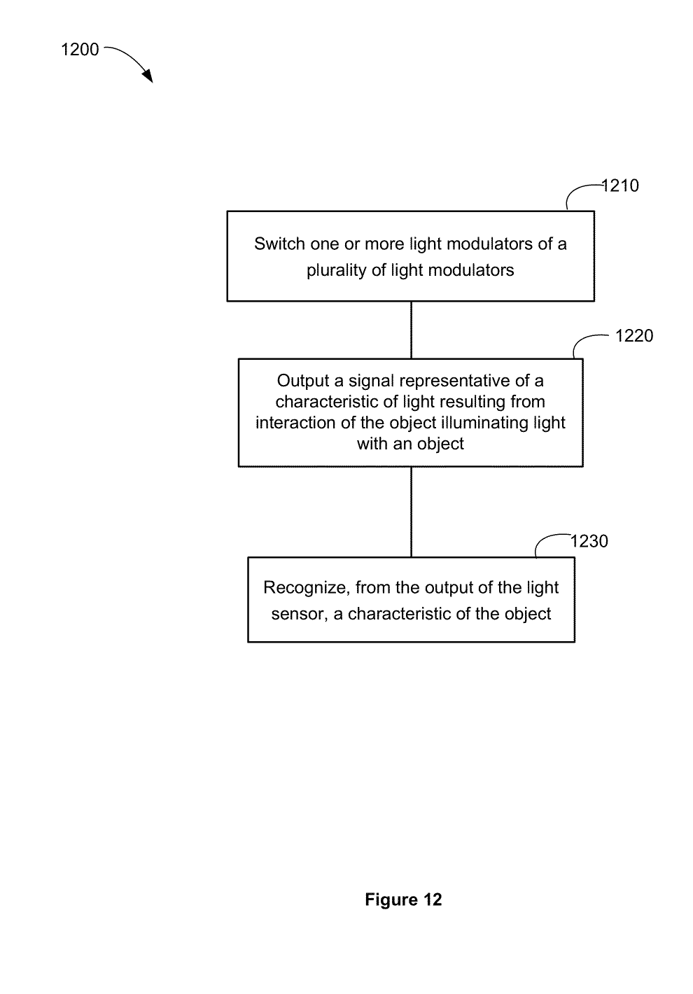

FIG. 12 illustrates an example of a process flow for recognizing a characteristic of an object with an FSC display according to an embodiment. At block 1210 of process 1200, one or more light modulators of a plurality of light modulators may be switched in accordance with a first modulation scheme to render an image, and in accordance with a second modulation scheme to selectively pass object illuminating light through at least one of the respective apertures. Advantageously, the object illuminating light may be at least partially unrelated to the image. In some implementations, the light modulators may be switched by a processor configured to control the FSC display. As described hereinabove, the FSC display may have a display front surface including a viewing area. The FSC display may include a transparent substrate, a display lighting system, at least one light sensor, and a plurality of light modulators for spatial light modulation. Each light modulator may include a shutter assembly configured as a micro electromechanical (MEM) device disposed proximate to a rear surface of the transparent substrate. Each light modulator may be configured to be switched between an open position that permits transmittance of light from the display lighting system through a respective aperture to the front surface and a shut position that blocks light transmission through the respective aperture. The transparent substrate is disposed substantially parallel to the front surface and between the display backlight system and the front surface. The light modulators may be switched in accordance with a first modulation scheme to render an image, and in accordance with a second modulation scheme to selectively pass object illuminating light through at least one of the respective apertures, the object illuminating light being at least partially unrelated to the image. The transparent substrate may be configured to pass light emitted by the display lighting system toward the display front surface and to receive light reflected through the display front surface from the object. The light sensor may be disposed within the viewing area and proximate to the rear surface of the transparent substrate.

At block 1220, the light sensor may output to the processor a signal representative of a characteristic of received light resulting from interaction of the object illuminating light with an object.

At block 1230, the processor may recognize, from the output of the light sensor, a characteristic of the object. The characteristic may include one or more of a location, or a motion of the object, or image data. Advantageously, the processor may control the display, responsive to the characteristic

Thus, improved implementations relating to an interactive FSC display have been disclosed. In some of the above described implementations, the display lighting system may include light sources configured to be fully or partially modulated at some frequency or signal pattern. In such implementations, the processor may include and/or be coupled with light sensor readout circuitry that includes an active or passive electrical band-pass frequency filter or other means to correlate the modulator signal pattern. In addition to modulation, the intensity of the light sources may be scaled to the (possibly lower or higher) appropriate amount of light for scanning rather than displaying information.

The various illustrative logics, logical blocks, modules, circuits and algorithm steps described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and steps described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some implementations, particular steps and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium. The steps of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above also may be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein. The word “exemplary” is used exclusively herein to mean “serving as an example, instance, or illustration.” Any implementation described herein as “exemplary” is not necessarily to be construed as preferred or advantageous over other possibilities or implementations. Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of an apparatus as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, a person having ordinary skill in the art will readily recognize that such operations need not be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

1. An apparatus comprising:
a field sequential color (FSC) display, having a display front surface including a viewing area, the FSC display including:
a transparent substrate;
a display lighting system;
at least one light sensor; and
a plurality of light modulators for spatial light modulation, wherein:
each light modulator includes a shutter assembly configured as a micro electromechanical (MEM) device disposed proximate to a rear surface of the transparent substrate;
each light modulator is configured to be switched between an open position that permits transmittance of light from the display lighting system through a respective aperture to the front surface and a shut position that blocks light transmission through the respective aperture;
the transparent substrate is disposed substantially parallel to the front surface and between the display backlight system and the front surface;
the transparent substrate is configured to pass light emitted by the display lighting system toward the display front surface and to receive light reflected through the display front surface from an object; and
the at least one light sensor is disposed within the viewing area and proximate to the rear surface of the transparent substrate.

2. The apparatus of claim 1, wherein the display lighting system includes at least one infrared (IR) light emitter, configured to emit IR light into an optical cavity, the optical cavity including a light turning arrangement for redirecting the emitted IR light through the transparent substrate and the display front surface, wherein
the at least one light sensor includes an IR light sensor; and
the transparent substrate is configured to pass the emitted IR light toward the front surface and to receive, through the display front surface, IR light scattered by the object.

3. The apparatus of claim 2, further comprising a processor, the processor being configured to recognize, from an output of the IR light sensor, a location of the object.

4. The apparatus of claim 2, wherein the display lighting system emits visible light during a first number of sub-frames and emits IR light during a second number of sub-frames.

5. The apparatus of claim 2 wherein the IR light emitter is flashed during a sub-frame where image data is being displayed.

6. The apparatus of claim 1, wherein the at least one light sensor includes a thin film transistor (TFT).

7. The apparatus of claim 6, further including a black mask disposed above the TFT, the black mask configured to include a window through which the light reflected through the display front surface from the object may reach the TFT.

8. The apparatus of claim 1, wherein the at least one light sensor includes photosensitive material and wiring deposited onto the transparent substrate.

9. The apparatus of claim 8, further comprising a black mask disposed on a back side of the photosensitive material.

10. The apparatus of claim 1, further comprising a processor, wherein:
the light modulators are switched in accordance with a first modulation scheme to render an image;
the light sensor is configured to output, to the processor, a signal representative of a characteristic of the received, redirected light; and
the processor is configured to switch the light modulators in accordance with a second modulation scheme to selectively pass object illuminating light through at least one of the respective apertures, the object illuminating light being at least partially unrelated to the image; and recognize, from the output of the light sensor, a characteristic of the object.

11. The apparatus of claim 10, wherein the second modulation scheme includes a sensing pattern interspersed between visible image patterns.

12. The apparatus of claim 11, wherein the sensing pattern includes a raster scan.

13. The apparatus of claim 10, wherein the processor controls the display, responsive to the characteristic.

14. The apparatus of claim 10, wherein the characteristic is one or more of a location, or a motion of the object.

15. The apparatus of claim 1, wherein each light modulator is disposed on the rear surface of the transparent substrate

16. The apparatus of claim 1, wherein the object includes one or more of a hand, finger, hand held object, and other object under control of a user.

17. An apparatus comprising:
a field sequential color (FSC) display, having a display front surface including a viewing area, and including:
a transparent substrate;
a display lighting system;
at least one light sensor;
a plurality of light modulators for spatial light modulation, wherein:
each light modulator includes a shutter assembly configured as a micro electromechanical (MEM) device disposed proximate to a rear surface of the transparent substrate;
each light modulator is configured to be switched between an open position that permits transmittance of light from the display lighting system through a respective aperture to the front surface and a shut position that blocks light transmission through the respective aperture;
the transparent substrate is disposed substantially parallel to the front surface and between the display backlight system and the front surface;
the transparent substrate is configured to pass light emitted by the display lighting system toward the display front surface and to receive light reflected through the display front surface from an object;
the at least one light sensor is disposed within the viewing area and proximate to the rear surface of the transparent substrate;
the light modulators are switched in accordance with a first modulation scheme to render an image;
the light sensor is configured to output, to the processor, a signal representative of a characteristic of the received, redirected light; and
means for switching the light modulators in accordance with a second modulation scheme to selectively pass object illuminating light through at least one of the respective apertures, the object illuminating light being at least partially unrelated to the image, and for recognizing, from the output of the light sensor, a characteristic of the object.

18. The apparatus of claim 17, further comprising a processor, wherein the second modulation scheme includes a sensing pattern interspersed between visible image patterns.

19. A method comprising:
switching, with a processor, one or more of a plurality of light modulators for spatial light modulation, wherein:
a field sequential color (FSC) display, has a display front surface including a viewing area, the FSC display including:
a transparent substrate;
a display lighting system;
at least one light sensor; and
the plurality of light modulators;
each light modulator includes a shutter assembly configured as a micro electromechanical (MEM) device disposed proximate to a rear surface of the transparent substrate;
each light modulator is configured to be switched between an open position that permits transmittance of light from the display lighting system through a respective aperture to the front surface and a shut position that blocks light transmission through the respective aperture;
the transparent substrate is disposed substantially parallel to the front surface and between the display backlight system and the front surface;
the light modulators are switched in accordance with a first modulation scheme to render an image, and in accordance with a second modulation scheme to selectively pass object illuminating light through at least one of the respective apertures, the object illuminating light being at least partially unrelated to the image;
the transparent substrate is configured to pass light emitted by the display lighting system toward the display front surface and to receive light reflected through the display front surface from an object; and
the at least one light sensor is disposed within the viewing area and proximate to the rear surface of the transparent substrate;
outputting, from the light sensor to the processor, a signal representative of a characteristic of the received, redirected light;
switching the light modulators in accordance with a second modulation scheme to selectively pass object illuminating light through at least one of the respective apertures, the object illuminating light being at least partially unrelated to the image, and
recognizing, with the processor, from the output of the light sensor, a characteristic of the object.

20. The method of claim 19, wherein the characteristic is one or more of a location, or a motion of the object.
